(19) United States
(12) Patent Application Publication
(10) Pub. No.: US 2008/0210603 A1
(43) Pub. Date: Sep. 4, 2008

(54) DRIVE FOR VIBRATORY SCREENING DEVICE

(76) Inventor: Allan Skoropa, West Bloomfield, MI (US)

Correspondence Address: HARNESS, DICKEY & PIERCE, P.L.C., P.O. BOX 828, BLOOMFIELD HILLS, MI, 48303, US

(21) Appl. No.: 12/040,312

(22) Filed: Feb. 29, 2008

Related U.S. Application Data
(60) Provisional application No. 60/892,706, filed on Mar. 2, 2007.

(51) Int. Cl. B07B 1/34

(52) U.S. Cl. 209/326

(57) ABSTRACT

A screening mechanism may include a drive motor, a vibratory drive assembly, a driven mechanism, and a belt assembly. The drive motor may be drivingly engaged with a motor hub. The vibratory drive assembly may include a shaft assembly having a first driven hub fixed thereto. The driven mechanism may have a second driven hub fixed thereto. The belt assembly may include a first belt engaged with the motor hub and the first driven hub that drives rotation of the first driven hub by rotation of the motor hub and a second belt engaged with the first and second driven hubs that drives rotation of the second driven hub by rotation of the first driven hub.

### CROSS-REFERENCE TO RELATED APPLICATIONS

This application claims the benefit of U.S. Provisional Application No. 60/892,706, filed on Mar. 2, 2007. The disclosure of the above application is incorporated herein by reference in its entirety.

### FIELD

The present disclosure relates to screening devices, and more specifically to drive systems for vibratory screening devices.

### BACKGROUND

The statements in this section merely provide background information related to the present disclosure and may not constitute prior art.

Vibratory screening devices typically include a drive shaft including eccentric weights. The eccentric weights create a vibratory drive for a screening assembly upon rotation of the drive shaft. The drive shaft is typically rotationally driven by a drive motor. The drive motor may also be used to power additional driven components of the screening device, such as a loading conveyor. The motor is typically sized based on the sum of the maximum load of each of the components that are driven by the motor.

### SUMMARY

A screening mechanism may include a drive motor, a vibratory drive assembly, a driven mechanism, and a belt assembly. The drive motor may be drivingly engaged with a motor hub. The vibratory drive assembly may include a shaft assembly having a first driven hub fixed thereto. The driven mechanism may have a second driven hub fixed thereto. The belt assembly may include a first belt engaged with the motor hub and the first driven hub that drives rotation of the first driven hub by rotation of the motor hub and a second belt engaged with the first and second driven hubs that drives rotation of the second driven hub by rotation of the first driven hub.

The second driven hub may be driven by rotation of the first driven hub from the motor hub and a rotational inertia created by a rotational imbalance of the shaft assembly.

A method may include powering rotation of a vibratory drive shaft of a screening mechanism using a drive motor, vibrating a screen assembly of the screening mechanism coupled to the vibratory drive shaft by a rotational imbalance of the vibratory drive shaft, and powering rotation of a driven device of the screening mechanism by a rotational inertia of the vibratory drive shaft created by the rotational imbalance.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is perspective view of a screening mechanism according to the present disclosure;

FIG. 2 is a perspective view of a shaft assembly of the screening mechanism of FIG. 1; and

FIG. 3 is a front plan view of a belt assembly of the screening mechanism of FIG. 1.

### DETAILED DESCRIPTION

The following description is merely exemplary in nature and is not intended to limit the present disclosure, application, or uses. It should be understood that throughout the drawings, corresponding reference numerals indicate like or corresponding parts and features.

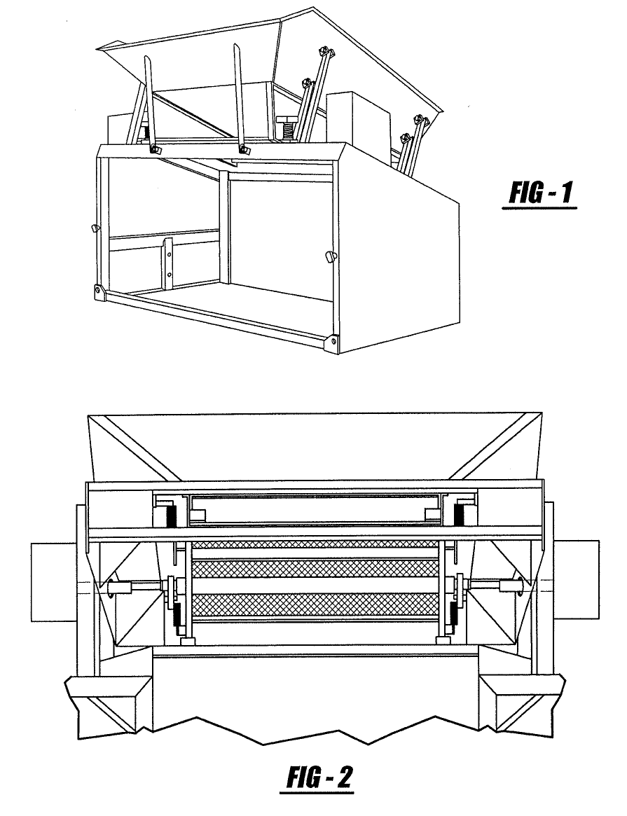

With reference to FIG. 1, a screening mechanism 10 may include a frame 12 supporting a drive assembly 14, a screening assembly 16, and a loading assembly 18. Drive assembly 14 may include a drive motor 20, a vibratory drive assembly 22, a driven mechanism 24, and a belt assembly 26. Drive motor 20 may include a gas-powered motor and may include an output shaft 28 drivingly engaged with a motor hub 30.

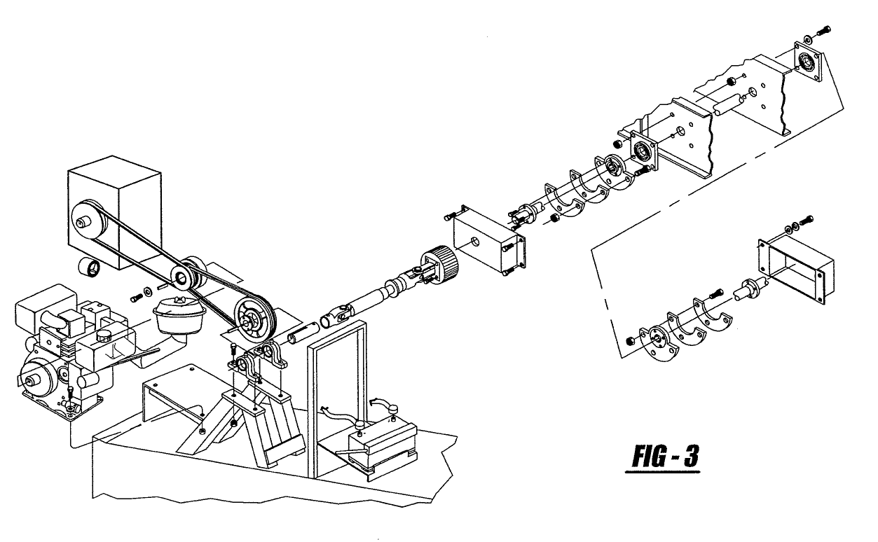

Vibratory drive assembly 22 may include a shaft assembly 32 having a hub 34 fixed thereto. With additional reference to FIG. 2, shaft assembly 32 may include first, second, and third portions 36, 38, 40 coupled to one another by first and second universal joints 42, 44. First portion 36 may may be fixed to hub 34 at a first end thereof and may be rotatably supported by a bearing 50 fixed to frame 12 at a second end thereof. Second portion 38 may extend between first and second universal joints 42, 44. Third portion 40 may include a first eccentric weight 56 fixed to a first end and a second eccentric weight 58 fixed to a second end.

Driven mechanism 24 may include a hydraulic pump. With additional reference to FIG. 3, driven mechanism 24 may include a hub 64 coupled to an input shaft (not shown) that drives driven mechanism 24. Belt assembly 26 may include a belt tensioner 66 fixed to frame 12 and first, second, and third belts 68, 70, 72. First and second belts 68, 70 may be engaged with motor hub 30, hub 34 of vibratory drive assembly 22 and tensioner 66. Shaft assembly 32 may be rotationally driven by drive motor 20. Third belt 72 may be engaged with hub 34 and hub 64 of driven mechanism 24. Rotation of shaft assembly 32 may drive driven mechanism 24.

Screening assembly 16 may include a screen base 74 having a screen 76 fixed thereto. Third portion 40 of shaft assembly 32 may extend through screen base 74 and may be engaged therewith to transmit vibration of shaft assembly 32 thereto. Loading assembly 18 may include a conveyor 78 powered by driven mechanism 24 and coupled to frame 12. Conveyor 78 may provide a material to screening assembly 16.

During operation, drive motor 20 may drive rotation of hub 34 through engagement with first and second belts 68, 70, as discussed above. Rotation of hub 34 may drive rotation of shaft assembly 32 as well as rotation of hub 64 through engagement with third belt 72. As such, the load on motor 20 may include both the load to power rotation of shaft assembly 32 and the load to power rotation of driven mechanism 24.

As shaft assembly 32 rotates, a rotational imbalance may be generated by eccentric weights 56, 58. The rotational imbalance may cause shaft assembly 32 to vibrate. Vibration of shaft assembly 32 may be transmitted to screening assembly 16, as discussed above.

The rotational imbalance may additionally provide an inertial drive force for rotation of shaft assembly 32, and therefore hub 34. More specifically, as driven mechanism 24 is driven by shaft assembly 32, a rotational inertia generated by eccentric weights 56, 58 may create the inertial drive force to supplement motor 20 in driving driven mechanism 24. As a result, the load on motor 20 may be reduced by the rotational inertia of eccentric weights 56, 58. Motor 20 may therefore be sized to have a power output to handle a load that is less than the sum of the peak load from shaft assembly 32 and the peak load from driven mechanism 24.

Those skilled in the art can now appreciate from the foregoing description that the broad teachings of the present disclosure can be implemented in a variety of forms. Therefore, while this disclosure has been described in connection with particular examples thereof, the true scope of the disclosure should not be so limited since other modifications will become apparent to the skilled practitioner upon a study of the drawings, the specification and the following claims.

What is claimed is:

1. A screening mechanism comprising:
a drive motor drivingly engaged with a motor hub;
a vibratory drive assembly including a shaft assembly having a first driven hub fixed thereto;
a driven mechanism having a second driven hub fixed thereto; and
a belt assembly including a first belt engaged with said motor hub and said first driven hub that drives rotation of said first driven hub by rotation of said motor hub and a second belt engaged with said first and second driven hubs that drives rotation of said second driven hub by rotation of said first driven hub.

2. The screening mechanism of claim 1, wherein said shaft assembly includes a weight thereon that creates an imbalance during rotation of said shaft assembly.

3. The screening mechanism of claim 2, wherein said imbalance reduces a power requirement of said motor by assisting in driving said second driven hub through a shaft inertia resulting from said imbalance.

4. The screening mechanism of claim 2, further comprising a screen assembly, said vibratory drive assembly engaged with said screen assembly and vibrating said screen assembly based on said imbalance of said shaft assembly.

5. The screening mechanism of claim 4, further comprising a conveyor that transports a material to said screen assembly, said driven mechanism driving said conveyor.

6. The screening mechanism of claim 2, wherein said shaft assembly includes first and second portions connected to one another through a universal joint, said first portion fixed to said first driven hub and said second portion including said weight thereon.

7. The screening mechanism of claim 1, wherein said driven mechanism includes a hydraulic pump.

8. A screening mechanism comprising:
a drive motor drivingly engaged with a motor hub;
a vibratory drive assembly including a shaft assembly having a rotational imbalance and a first driven hub fixed thereto;
a driven mechanism having a second driven hub fixed thereto; and
a belt assembly including a first belt engaged with said motor hub and said first driven hub that drives rotation of said first driven hub by rotation of said motor hub and a second belt engaged with said first and second driven hubs that drives rotation of said second driven hub by rotation of said first driven hub from said motor hub and a rotational inertia created by said rotational imbalance of said shaft assembly.

9. The screening mechanism of claim 8, wherein said imbalance reduces a power requirement of said motor by assisting in driving said second driven hub through said rotational inertia resulting from said rotational imbalance.

10. The screening mechanism of claim 8, further comprising a screen assembly, said vibratory drive assembly engaged with said screen assembly and vibrating said screen assembly based on said rotational imbalance of said shaft assmebly.

11. The screening mechanism of claim 10, further comprising a conveyor that transports a material to said screen assembly, said driven mechanism driving said conveyor.

12. The screening mechanism of claim 8, wherein said shaft assembly includes first and second portions connected to one another through a universal joint, said first portion fixed to said first driven hub and said second portion including a weight thereon that creates said rotational imbalance.

13. The screening mechanism of claim 8, wherein said driven mechanism includes a hydraulic pump.

14. A method comprising:
powering rotation of a vibratory drive shaft of a screening mechanism using a drive motor;
vibrating a screen assembly of said screening mechanism coupled to said vibratory drive shaft by a rotational imbalance of said vibratory drive shaft; and
powering rotation of a driven device of said screening mechanism by a rotational inertia of said vibratory drive shaft created by said rotational imbalance.

15. The method of claim 14, wherein said powering rotation of the vibratory drive shaft includes providing a direct engagement between an output of said drive motor and said vibratory drive shaft.

16. The method of claim 15, wherein said direct engagement includes a belt coupling said output of said motor to said drive shaft.

17. The method of claim 14, wherein said powering rotation of the driven device includes providing a direct engagement between said vibratory drive shaft and said driven device.

18. The method of claim 17, wherein said direct engagement includes a belt coupling said drive shaft to said driven device.

19. The method of claim 14, wherein powering said driven device includes powering a hydraulic pump.

20. The method of claim 19, wherein said powering the hydraulic pump powers a conveyor that provides a material to said screening assembly.
